(19) United States
(12) Patent Application Publication
(10) Pub. No.: US 2024/0185447 A1
(43) Pub. Date: Jun. 6, 2024

(54) INTERACTIVE PROCEDURAL GUIDANCE

(71) Applicant: LabLight AR Inc., Seattle, WA (US)

(72) Inventors: Roger BRENT, Seattle, WA (US); John Anthony MEIN, Seattle, WA (US); Nikolas STIRES, Seattle, WA (US); Karrington OGANS, Seattle, WA (US)

(21) Appl. No.: 18/531,667

(22) Filed: Dec. 6, 2023

Related U.S. Application Data
(60) Provisional application No. 63/430,445, filed on Dec. 6, 2022.

(51) Int. Cl. G06T 7/70; G06F 3/01; G06T 11/00; G06V 20/20

(52) U.S. Cl. CPC G06T 7/70; G06F 3/012; G06T 11/00; G06V 20/20; G06T 2207/10028

(57) ABSTRACT

Methods, systems, and apparatus, including computer programs encoded on a computer storage medium, directed to an interactive procedural guidance system are disclosed. In one aspect, a method includes the actions of receiving, by an interactive procedural system, first sensor data that reflects first characteristics of an environment where a user wearing an augmented, mixed, or extended reality headset is located. The actions further include determining a location of an object within a field of view of the AR/MR/XR headset. The actions further include identifying a type of the object. The actions further include determining a skin that is configured to be displayed to the user through the headset over the object. The actions further include receiving second sensor data that reflects second characteristics of the environment. The actions further include determining that an event has occurred with respect to the object. The actions further include updating the skin.

### CROSS-REFERENCE TO RELATED APPLICATION

This application claims the benefit of U.S. application 63/430,445, filed Dec. 6, 2022, which is incorporated by reference.

### BACKGROUND

Presently, Augmented, Mixed, and extended Reality (“AR/MR/XR”) devices and computing platforms have become readily available to both the personal and commercial markets in general and have enjoyed success. In the case of personal markets, AR/MR/XR gaming continues to grow. In the commercial sphere, applications around training and simulation enjoy increasing traction.

One commercial application is the notion of interactive procedural guidance. Specifically, in interactive procedural guidance, a user is placed in an AR/MR/XR environment that monitors substantively in real time the activities of the user and the user's workspace. As the user performs procedures, i.e., a series of tasks following a sequential and/or conditional workflow, the AR/MR/XR environment ideally is able to provide feedback to the user.

However, present interactive procedural guidance applications, both AR/MR/XR and non-AR/MR/XR, do not have sufficient information to support complex and highly sensitive workflows such as for laboratory work. Specifically, there exists a class of workflows, that are characterized as complex workflows, where the proper execution depends on not only the identification of physical objects to be manipulated (also called “artifacts”), but also the locations, pose/attitude, and motion through space and time of those artifacts. Furthermore, there exists a class of workflows, that is characterized as highly sensitive workflows, where the configuration of the user, user activities, and artifacts in the user's workspace, as well as the evolution of that configuration over time would ideally be interpreted as of consequence to be brought to the attention of a user or other party. Consider a complex scenario where the artifacts are compound objects that is to say multiple artifacts to be tracked are superimposed on the same space, such as a flask and the contents of a flask. Present AR/MR/XR could be configured to recognize a flask, and even determine whether the flask is full or not. However, present AR/MR/XR does not determine whether the flask is tilted, or is filled with sulfuric acid, let alone an interpretation of the sensitive nature of the scenario, specifically present AR/MR/XR does not understand the consequences/dangers of strong acid about to leave a flask.

In short, specifically, the quality and sufficiency of feedback by an application are contingent on the AR/MR/XR interactive procedural guidance application's information about the user's activity, workspace, artifacts the user is manipulating in the workspace, and context. Because prior applications do not have the ability to detect this information let alone interpret this information, prior applications lack the information and accordingly the fidelity and resolution for feedback for such a complex and highly sensitive workflow.

### SUMMARY

An innovative aspect of the subject matter described in this specification may be implemented in methods that include the actions of receiving, by an interactive procedural system, first sensor data that reflects first characteristics of an environment where a user wearing an augmented, mixed, or extended reality (AR/MR/XR) headset is located; based on the first sensor data, determining, by the interactive procedural system, a location of an object within a field of view of the AR/MR/XR headset; based on the first sensor data, identifying, by the interactive procedural system, a type of the object; based on the type of the object and the location of the object within the field of view of the AR/MR/XR headset, determining, by the interactive procedural system, a skin that is configured to be displayed to the user through the AR/MR/XR headset over the object; receiving, by the interactive procedural system, second sensor data that reflects second characteristics of the environment where the user wearing the AR/MR/XR headset is located; based on the second data, determining, by the interactive procedural system, that an event has occurred with respect to the object; and based on a type of the event that has occurred with respect to the object, updating, by the interactive procedural system, the skin that is configured to be displayed to the user through the AR/MR/XR headset over the object.

These and other implementations can each optionally include one or more of the following features. The first sensor data and the second sensor data are generated by sensors that (i) comprise a camera, a time of flight sensor, a structured illumination sensor, an infrared sensor, and a light detection and ranging scanner, (ii) that are integrated with the AR/MR/XR headset, and (ii) that are separate from the AR/MR/XR headset. The action of determining the location of the object within the field of view of the AR/MR/XR headset includes: determining a distance between the object and the AR/MR/XR headset; and determining a pose of the object. The action of determining the skin that is configured to be displayed to the user through the AR/MR/XR headset over the object is based on the distance between the object and the AR/MR/XR headset and based on the pose of the object.

The actions further include, based on the first sensor data, determining, by the interactive procedural system, an additional location of an additional object within a field of view of the AR/MR/XR headset; based on the first sensor data, identifying, by the interactive procedural system, a type of the additional object. The action of determining the skin of the that is configured to be displayed to the user through the AR/MR/XR headset over the object is further based on the type of the additional object and the additional location of the object within the field of view of the AR/MR/XR headset.

The event that has occurred with respect to the object includes: a change in the location of the object; a change in an additional location of an additional object; a change in a pose of the object or the additional object; a change in an additional pose of the additional object; a change in a first distance between the object and the AR/MR/XR headset; a change in a second distance between the additional object and the AR/MR/XR headset; a change in a third distance between the object and the additional object; and/or an interaction between the skin of the object and the user, the additional object, or an additional skin of the additional object.

The skin causes the object to appear larger to the user when the object is within the field of view of the AR/MR/XR headset. The actions further include accessing, by the interactive procedural system, a set of rules or a procedure related to an activity of the user. The action of determining that the event has occurred with respect to the object is further based on the set or rules or the procedure. The action of updating the skin that is configured to be displayed to the user through the AR/MR/XR headset over the object is further based on the set of rules or the procedure.

Other implementations of this aspect include corresponding systems, apparatus, and computer programs recorded on computer storage devices, each configured to perform the operations of the methods.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a context diagram for Interactive Procedural Guidance.

FIG. 2 is a diagram of an exemplary environment for Interactive Procedural Guidance.

FIG. 3 is a flow chart for an exemplary operation of an Interactive Procedural Guidance System.

FIG. 4 is a flow chart of another exemplary operation of an Interactive Procedural Guidance System.

### DETAILED DESCRIPTION

### A Developmental Program of Interactive Procedural Guidance

Described herein are Augmented, Mixed, or extended Reality (AR/MR/XR) that is the superimposition, via the user's sensorium, of entities made of information (made of computer-understandable bits) upon entities in the physical world (made of atoms). The development of workable “strong” AR/MR/XR devices, such as the first and second generation Hololens™, and the Magic Leap™ One and Two, demonstrates presently available hardware that can accomplish this task. The capabilities enabled by these hardware devices may potentially revolutionize complex and/or highly sensitive of procedures and workflows, including laboratory work, that require that people operate on or in response to information, and also on artifacts (physical objects). Put more generally, strong AR/MR/XR devices can enable the presentation of content providing procedural guidance, guidance that may be of particular utility for workers who spend much of their time interacting with the objects in the physical world using their hands. And yet current AR/MR/XR provides only a part of the ability needed to realize this vision.

Many of the most compelling imagined uses of AR/MR/XR, including the provision of procedural guidance, require particular abilities that current and near-future headsets do not have. These include: (a) an ability to identify or support the identification of physical objects, (b) an ability to determine, with high resolution and accuracy, the localization of artifacts/physical objects in the physical world, (c) an ability to determine, with high spatial resolution and accuracy, orientation (attitude or pose) of artifacts in the physical world, and (d) an ability to keep track of physical objects as they move or are moved through the physical world and change pose over time. They also include (e) an ability to generate high resolution, accurately spatially positioned and posed virtual objects in the user's sensorium, and adjust their location, pose, and shape over time. Finally, they include: (f), that, ideally, the AR system “understands” the work environment and the work task at hand, that is to say that a configuration of the user, the user's workspace, and the artifacts in the workspace, and potentially the evolution of the configuration over time can be interpreted.

Some of the above functionalities are also needed for some uses or Virtual Reality (VR). These include identification and accurate determination of the location and attitude of objects in the physical world (for example, the user's hands) in order to direct the localization and orientation of objects reified in the virtual world.

One reason current AR/MR devices cannot support these functions includes the fact that their ability to resolve and localize physical and virtual objects is only accurate within a few centimeters, while to a first approximation identification, tracking, and determination of pose for physical objects are not supported at all.

The consequence of this spatial inaccuracy and the other shortcomings of current AR/MR devices is that these devices cannot localize physical and virtual objects the size of screws, switches, knobs, or fingertips, and thus cannot provide guidance for procedures operating on objects of similar scales. These same limitations on spatial localization and precise determination of pose apply to VR devices in those instances where applications in VR need to localize and determine poses of objects in the physical world and use that information to generate objects or actions in the virtual world.

A second limitation of current and envisioned AR/MR/XR devices for applications including procedural guidance is the fact that since object identification and tracking are not carried out by the headsets, the additional processing needed to carry out these two functions is envisioned to be carried out not locally, but in the cloud. The need to carry out computation in the cloud introduces latency. It also carries with it security risks, including risks that information and processing carried out in the cloud may be accessible to the cloud service providers, that this information and processing might be breached by third parties, and that information passing to and from the cloud might be intercepted.

A third limitation of current and envisioned AR and MR devices for applications including procedural guidance is that off-device computation supporting object identification, object tracking, and determination of object pose can be carried out by deep neural networks trained to recognize individual objects and object classes, rather than using computational analytical geometry or other deterministic machine vision approaches. These networks have some disadvantages. They are frail when presented with data not represented in their training data. A second is that, due to the inscrutability of deep neural networks, it is difficult to impossible to troubleshoot errors made by the trained networks and correct those errors.

For these reasons, in previous scenarios the abilities of AR/MR and VR devices may be enhanced to carry out the following functions: (a) identify and support identification of physical objects, (b) carry out spatially accurate, high-resolution localization of physical objects, (c) carry out spatially accurate, high-resolution determination of orientation (attitude or pose) of physical objects, (d) track physical objects as they move or are moved through space and change pose over time, and (e) generate high resolution, accurately spatially positioned and posed virtual objects and adjust their location, pose, and shape over time.

For some of the envisioned uses of AR/MR/XR there is also a compelling need to carry out the computations supporting these functions locally, rather than in the cloud. In some embodiments, this functionality may be implemented on a local computer such as a laptop.

For some applications, including those for which troubleshooting might be essential, there may also be a need to: (a) support object identification and (b) determine object pose by analytical/computational methods rather than computational methods based on deep neural networks.

### Context for Interactive Procedural Guidance

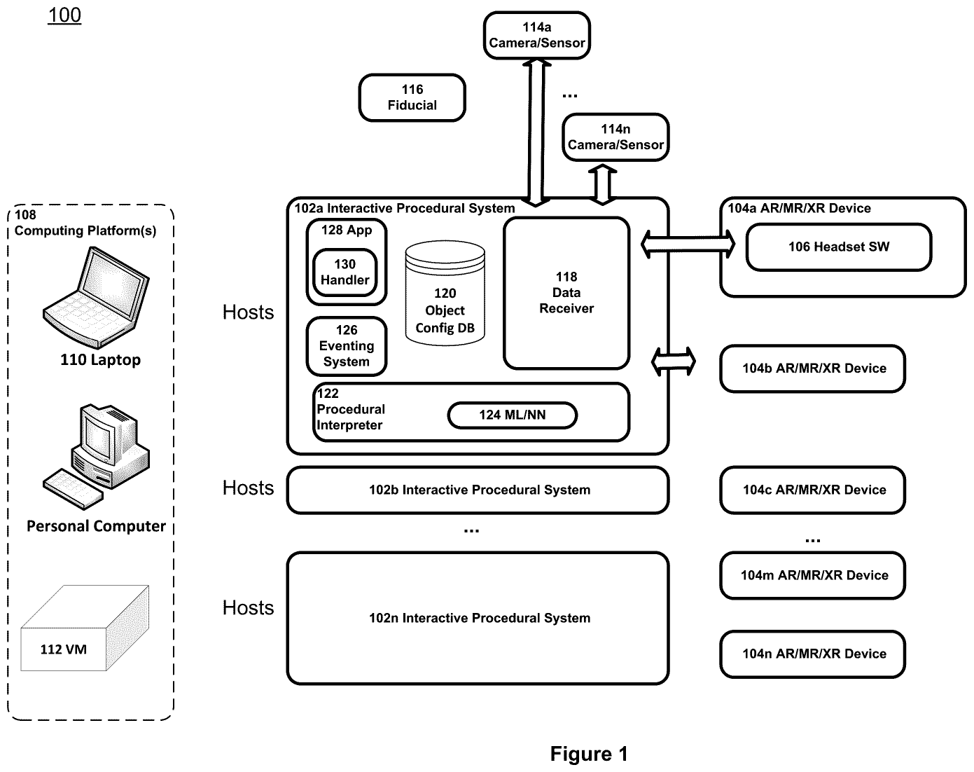

It is useful to describe the improved Interactive Procedural Guidance (IPG) system from a contextual perspective. For purposes of brevity, the terms Interactive Procedural Guidance System or IPG System may refer to the improved system supporting procedural guidance for complex and/or highly sensitive scenarios. FIG. 1 is a contextual diagram 100, of an IPG System 102.

The concept of operations is not just to use one IPG System 102 but potentially a plurality of IPG Systems 102 together with one or more AR/MR/XR devices 104 running client software. Specifically, an AR/MR/XR device 104 may be a headset, and an instance of client software 106 may run on the headset itself or on a computing platform such as a laptop 108 or virtual machine 110 hosted on the cloud dedicated to the specific AR/MR/XR device 104. In this way, the AR/MR/XR device 104 and the IPG System 102 in concert may generate precise and spatially accurate information about physical objects in the operator's environment and workspace and spatially accurate generation of virtual objects in the operator's visual and auditory fields.

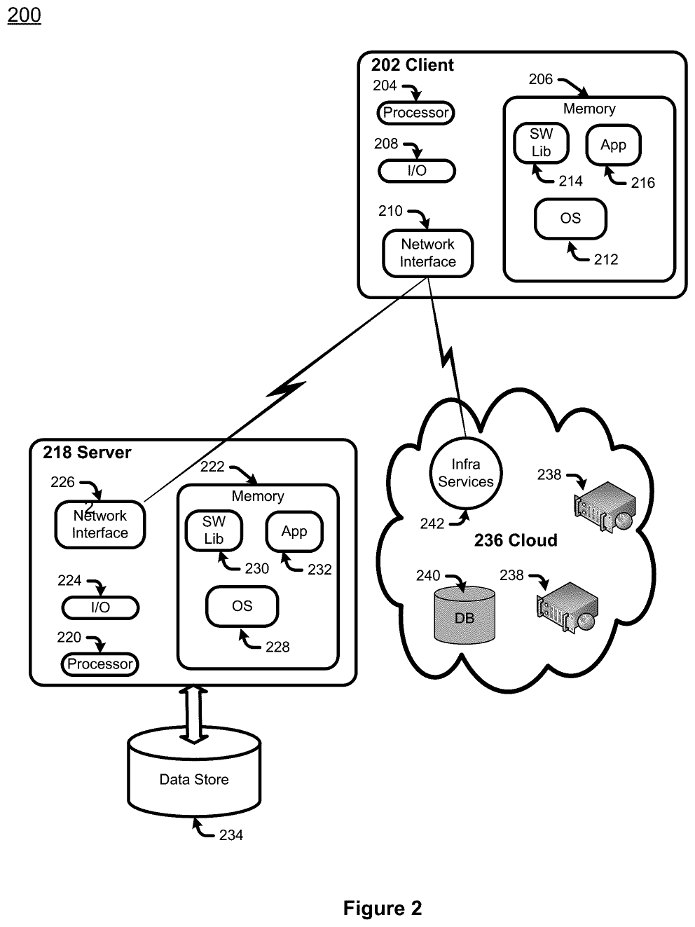

The IPG System 102 is comprised of both hardware and software. The software utilizes the graphics processor (GPU) of a computing platform and in some cases may use most of its capacity. The configuration of the computing platform is described in greater detail with respect to FIG. 2 below.

The IPG System 102 may utilize one or more video cameras and/or sensors 114. In the case of video cameras 114 the cameras have the capability to sense depth, for example by being paired with a Time of Flight (ToF) or structured illumination sensor, IR sensor, other LIDAR (light detection and ranging), or by a visual stereo camera. These characteristics of the video cameras 114 give the IPG System 102 its enhanced ability to sense and understand physical objects in the sensor's field of view (FoV). In some contexts, “DepthCam” may refer to any camera or combination of cameras and sensors 114 that can produce images and sense depth. This set of video cameras and sensors 114 enables not just the detection of objects, but also the attitude and/or orientation of those objects.

The IPG System 102 also makes use of computing resources 108. The computing resources 108 may be in the form of a local computing platform such as a laptop 110, or personal computers, each having one or more processors including one or more central processing units (CPU) and potentially with one or more GPUs. In some embodiments, the IPG System 102 may be hosted on a virtual machine in the cloud 112. Computing resources are described in further detail with respect to FIG. 2 below.

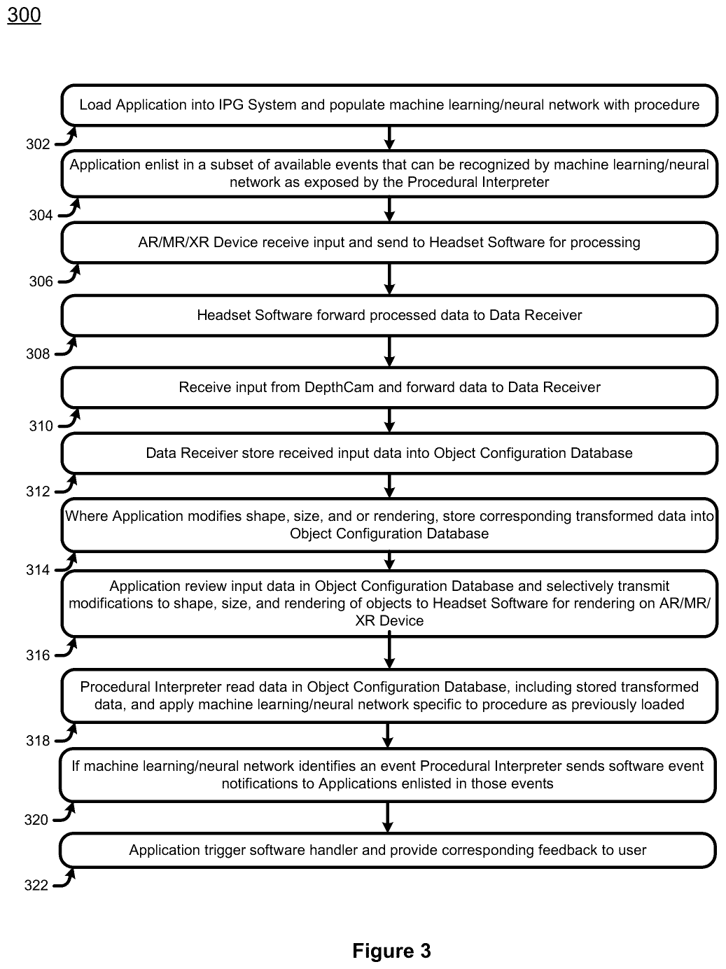

The IPG System 102 may carry out key sets of tasks. At a high level, the software analyses information, including image and depth, coming from one or more cameras/sensors either as part of an AR/MR/XR headset 104 or external to the headset in the DepthCam 114, either by deterministic means, by machine learning means, or any combination thereof. The IPG System 102 establishes a coordinate frame, or Local Coordinate System (LCS) within the sensed volume. Within the sensed volume the software supports identification of physical objects, localizes these objects precisely, determines the poses of physical objects precisely, and tracks the movements of physical objects through space. The software also generates accurately localized and posed virtual objects (visual and auditory) and supports their movement through space and change of pose. This process is described in further detail with respect to FIG. 3,

To perform this process, the headset 104 may translate positional and pose information into the Operator's Coordinate System, which is the coordinate frame referenced by the user. In some embodiments, the IPG System 102 may track the distance and pose of AR/MR/XR headsets 104 near it with respect to the LCS coordinates, and transmit all the above information about physical and virtual objects to those headsets, either pre-translated into the coordinate frame of the individual headsets.

It is worthwhile to discuss the relationships between the physical world, the LCS, and the OCS. Note that the physical world, the digital twin of the physical world, and the actual virtual world may potentially have different dimensions and behaviors. Furthermore, it may be desirable for different users on different AR/MR/XR headsets 104 to participate in the same virtual space. The IPG System 102 may posit a common coordinate system. The common coordinate system may simply mirror the existing coordinate system, or may make use of linear transforms and translations that map the coordinate systems deterministically to each other. For two-dimensional data, linear transformations and translations in the form of matrices are applied. For three-dimensional data, matrices, tensors, and quaternions (and other vector techniques) may be applied.

Furthermore, corresponding workflow events may be mapped even if the physical configurations of two workspaces are different. For example, if a workflow, as represented by a labeled transition system has different location and/or coordinate in one workspace (i.e., the sulfuric acid is in a flask on the left side of one laboratory bench of a user), as opposed to another workspace (i.e., the sulfuric acid is in a flask on the left side of the laboratory bench of another user), and application 128 may keep track of the different locations, but use machine learning neural net recognition on the different views.

In one embodiment, the IPG System 102 may connect to a single DepthCam 114 fixed in position, and so collect information from that fixed FoV that defines a subset of the volume accessible by the operator of the AR headset in which spatial resolution is high and spatial localization is accurate. An example of fixing the position of the DepthCam 114 is to clamp it to a shelf above a working area, or velcroing or taping it to the ceiling of a tissue culture hood. If the operator of the AR device 104 is carrying out procedural work, this volume seen by the DepthCam's 114 FoV may be referred to as the “working volume” or “workspace”.

More complex implementations may make use of multiple DepthCams 114 to create larger and or multiple zones of enhanced spatial accuracy or to “clone” instances of the Local Coordinate System and virtual objects within it at remote locations, to generate remote, spatially accurate and highly resolved, “pocket metaverses”.

In some embodiments, the IPG System 102 generates a basis coordinate frame by reference to an optically recognizable fiducial marker 116 such as an ArUCo or ChArUCo card. Before use, a process of registration establishes the equivalency of key pixels in image of the fiducial marker, for example using corners of the ChArUCo squares, that are seen both by the IPG System 102 and by the headset camera 104. As needed, a one-time process of calibration of each particular DepthCam 114 and the cameras used by each AR headset 104 may allow correction for “astigmatism”, any distortions or aberrations, caused, for example, by small imperfections in the camera optics arising during their manufacture.

In practice, the IPG System 102 uses its software to identify physical objects, for example by using a neural network, by operating on pre-existing geometric and feature data about objects, by defining objects as contiguous clumps of depth readings above the plane of the working surface, via detection via clumps of features by an OCN via declaration by the operator. It tracks the locations and poses of physical objects, and computes locations of virtual objects within the workspace with respect to the basis coordinate space. It uses information about headset location and pose to translate this information into the coordinate frame of the headset.

There are additional and potentially more complex embodiments. One is that after registration, the IPG System 102 sensor or sensors 104/114 are not fixed, but use optical and other information such as inertial positioning to compute its location and pose with respect to the original basis coordinate system. A second is the use of other objects for fiducial markers 116. A third is that multiple IPG Systems 102, fixed and/or mobile, might define larger working volumes sharing the basis coordinates of a first IPG System 102.

For applications including procedural guidance, a function of the IPG System 102 involves the system supporting object identification, object localization, pose determination, and object tracking, for both physical and virtual objects. The reason to have these functions handled by the headset 104 of the IPG System 102 is that these as of this writing functions are not presently carried out by first and next-gen AR/MR headsets 104. It is possible that later generation headsets 104 might have more processing power and take over more of these necessary functions. Accordingly, computing workload is likely to be distributed where the constituent computing tasks are divided between the host computing platform 108 (laptop 110 or cloud 112) and a headset client 114. These entities may communicate over WiFi, using TDP or UDP packets. The communications infrastructure of the IPG System is described in further detail with respect to FIG. 2 below.

Thus far, the use of one or more cameras/sensors, both in the headset 104 and external to the headset 114, including depth capabilities to capture visual information have been described. This information may be collected by the IPG System 102 for performing visual object recognition. Visual object recognition may be performed by a computational engine or by machine learning means. This includes not only visual object recognition of physical objects, but also the attitude and/or orientation of a physical object, the location of a physical object, and the time of capture of a location of a physical object. In some cases, supplementary data, such as audio for a particular time, is also captured. This information is received by a Data Receiver software component 118 and the information is stored by the Data Receiver 118 in an Object Configuration Database 120.

Beyond the identification and tracking of physical objects, the IPG System 102 is able to interpret the visual and supplementary data according to a machine learning neural net configured to recognize procedures. Specifically, a Procedural Interpreter software component 122 interprets the data in the stored Object Configuration Database, and then triggers software events using an Eventing System 126 where configurations are recognized by a machine learning neural net 124. Application 128 in the IPG System 102 that enlist in those software events via the Eventing System 126 may have software handler 130 to create software responses to those events.

For example, in the context of a procedural application 128 involving sulfuric acid, if a flask known to contain sulfuric acid is tilted, the machine learning neural net 124 may recognize a chemical hazard and the Eventing System 126 correspondingly may trigger a software event. An Application 128 being run in the IPG System 102 that enlisted in this software event may then have a software handler 130 that displays a hazard warning to the user, if in fact blocks performing subsequent steps until the hazard recognized by the machine learning neural net 124 is mitigated as recognized by the machine learning neural net 124.

Because the machine learning neural network 124 is interpreting events in the context of a procedure, or workflow, developers can then enlist in events using the context of the procedure to be modeled. Specifically, instead of looking for an event called “ActivateObject”, the event might be contextualized as “DecantFlask.” This may ease software development of applications and ensure that events are not missed due to events being published with generic contexts.

Additionally, note that the application 128 may choose to have the AR/MR/XR device 104 render virtual objects quite differently from the actual dimensions and appearance of the physical object. For example, the physical objects may be rendered with different shapes and sizes. This may be effected by modifying the wireframe for the rendered object to change shape, and modifying the shaders that represent the surface appearance (known colloquially as “skins”) on the wireframe. Reasons to change the shape are manifold, but in one embodiment, it may be desirable to have a flask appear larger in the virtual world such that when the virtual flask collides with another virtual object, in the physical world, the physical flask is smaller and does not in fact collide. This in effect achieves a “safety buffer.” Also, reasons to change the appearance of an object are manifold, but in one embodiment, it may be desirable to highlight or otherwise change the color of an item that is in a hazardous situation, such as red.

These capabilities in sum enable a wide range of scenarios. Some of the capabilities are articulated with respect to the Section entitled “Use Cases of Interactive Procedural Guidance” below.

### Exemplary Environment for Interactive Procedural Guidance

For the context of an Interactive Procedural Guidance System, FIG. 2 describes an environmental diagram 200 that includes an exemplary hardware, software, and communications computing environment. Specifically, the functionality for the Interactive Procedural Guidance System is generally hosted on a computing device. Exemplary computing devices include without limitation personal computers, laptops, embedded devices, tablet computers, smartphones, and virtual machines. In many cases, computing devices are to be networked.

One computing device may be a client computing device 202. The client computing device 202 may have a processor 204 and a memory 206. The processor may be a central processing unit, a repurposed graphical processing unit, and/or a dedicated controller such as a microcontroller. The client computing device 202 may further include an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). The network interface 210, may potentially work in concert with the I/O interface 208 and may be a network interface card supporting Ethernet and/or Wi-Fi and/or any number of other physical and/or datalink protocols.

Memory 206 is any computer-readable media that may store software components including an operating system 212, software libraries 214, and/or software applications 216. In general, a software component is a set of computer-executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. As defined herein, computer storage media does not include communication media.

A server 218 is any computing device that may participate in a network. The network may be, without limitation, a local area network (“LAN”), a virtual private network (“VPN”), a cellular network, or the Internet. The server 218 is similar to the host computer for the image capture function. Specifically, it may include a processor 220, a memory 222, an input/output interface 224, and/or a network interface 228. In the memory may be an operating system 228, software libraries 230, and server-side applications 232. Server-side applications include file servers and databases including relational databases. Accordingly, the server 218 may have a data store 234 comprising one or more hard drives or other persistent storage devices.

A service on the cloud 236 may provide the services of a server 218. In general, servers may either be a physical dedicated server, or may be embodied in a virtual machine. In the latter case, the cloud 236 may represent a plurality of disaggregated servers that provide virtual application server 238 functionality and virtual storage/database 240 functionality. The disaggregated servers are physical computer servers, which may have a processor, a memory, an I/O interface, and/or a network interface. The features and variations of the processor, the memory, the I/O interface, and the network interface are substantially similar to those described for the server 218. Differences may be where the disaggregated servers are optimized for throughput and/or for disaggregation.

Cloud 236 services 238 and 240 may be made accessible via an integrated cloud infrastructure 242. Cloud infrastructure 242 not only provides access to cloud services 238 and 240 but also to billing services and other monetization services. Cloud infrastructure 242 may provide additional service abstractions such as Platform as a Service (“PAAS”), Infrastructure as a Service (“IAAS”), and Software as a Service (“SAAS”).

### Exemplary Operation of the Interactive Procedural Guidance System

FIG. 3 is an exemplary flow chart 300 of the operation of the IPG System 102. In block 302, the IPG System 102 loads an application 128. This involves the application logic that is in the IPG System 102, the associated machine learning/neural network 124 that is trained on the procedure to be monitored and guided, and any Headset software 106 is loaded into the AR/MR/XR Device 104.

Note that the machine learning/neural network 124 may expose through the Procedural Interpreter 122 one or more events indicating recognized configurations or sequences of configurations over time. In block 304, the application 128 enlists a subset of those events as exposed and published by the Procedural Interpreter 122.

At this point, an operation by the user starts. The user may perform an activity in their workspace as defined by the work volume, the artifacts in the volume, and the activities of the user. The workspace and a discussion of the different coordinate systems are described in further detail above. In block 306 the AR/MR/XR Device 104 receives input and sends the received input to the Headset Software 106 for processing. Here the processing may involve performing software corrections such for lens flaws and/or astigmatism. The corrections may involve the application of transformation and translation matrices that move pixels in received images to enable correction. After processing, in block 308 the Headset Software 106 forwards the processed data to Data Receiver 118.

Note that the application 128 is also receiving data from the DepthCam i.e., the set of external cameras and sensors 114 outside of the AR/MR/XR device 104. Note that the data here need not only be video data and time stamp data. Sensors can be any sensor including transducers such as audio microphones, or alternatively temperature gauges, vibration detectors, or even non-sensory telemetry, and the like. In block 310 the DepthCam 114 captures this input and forwards the data to the Data Receiver 118.

Periodically, in block 312 the Data Receiver 118 may store received input data into Object Configuration Database 120. Recall that the application 128 may be configured to create virtual renderings of the physical objects that are different than the real-world shape, size, and or appearance of those physical objects. In block 314 where application 128 modifies shape, size, and or rendering, the Data Receiver 118 stores the corresponding transformed data into Object Configuration Database 120. The transformations may make use of matrix, tensor, quaternion, and other linear algebra-based transformations and/or may include different shaders to create different skins and renderings.

If the application 128 is in fact making use of such modifications, in block 316 the application 128 reviews the input data in Object Configuration Database 120 and then selects modifications to shape, size, and rendering of objects and transmits to Headset Software 106. The Headset Software 106 then renders the modifications for rendering on AR/MR/XR Device 104.

In block 318 the Procedural Interpreter 122 reads data in Object Configuration Database 120, including the stored transformed data where the application 128 has specified modifications, and then applies the machine learning/neural network 124 as previously loaded in block 302.

If the machine learning/neural network 124 identifies an event from the read data, in block 320, the Procedural Interpreter 122 sends software event notifications to application 128 enlisted in those events. In this case, in block 322, application 128 may then trigger software handler 130 in response to the received software event notification and provide corresponding feedback to the user.

### Use Cases for Interactive Procedural Guidance

The systems and techniques described herein may be used for a wide range of applications. By way of example, using the interactive procedural guidance as described herein can enhance the user experience. The context of a chess game may be used to enumerate interactive procedural guidance capabilities and enhancements. As another example that illustrates an additional potential application of those capabilities, the interactive procedural guidance can provide enhancement in the context of laboratory operations. As stated above, these scenarios are merely exemplary and not intended to be limiting.

Turning to the first example, a virtual chess game provides several interactive procedural guidance opportunities for enhancements. Recall that the IPG System described above supports the following capabilities: (1) the capability of rendering artifacts, i.e., creating virtual objects corresponding to physical objects either with high fidelity, both video and audio, or differently, and where rendered differently having the ability to resolve the discrepancies, (2) better recognition of objects, including attitude and orientation, (3) interpretation of the user, workspace, and artifacts within the workspace. For example, some capabilities pertain to suggesting next actions in response to an action taken by the human operator and warning the operator if she is about to make a bad move, and in this way illustrating an interpretation of the configuration of the artifacts by the system. In some cases, the interpretation is performed by a machine learning system such as a trained neural network, which may be trained to interpret chess moves.

A set of potential capabilities made possible by the system include:
(1) Accurate detection of physical chess pieces by a trained system, not only of the locality of the chess pieces as to be accurate as to their location on a chessboard (or off the board), but also the attitude and orientation such as a piece that has been captured, potentially lying down. Consider the position of a king that is laying down on the board, as being interpretable as the other party resigning from the game. This is effected at least by augmenting the data collected from the workspace using a DepthCam 114 coupled with a machine learning/neural network 124 that is specific to an application (here Chess) in blocks 310 and 318 of FIG. 3.
(2) Visual display of virtual chess pieces may have virtual sheathing or skins. This emphasizes that the virtual display of the physical objects themselves need not be the same as in the real world. This can enhance the aesthetics of the pieces, or alternatively enable emphasis (such as illustrating the piece that was just moved). Note that the IPG System 102 can track whether to sheath the physical chess pieces identified by the system with virtual chess pieces either of identical shape and size, or of different shape or size. Note that these differences are to be resolved by the system to detect collisions between virtual objects as opposed to the underlying physical objects. This resolution is effected at least as described with respect to blocks 314 and 318 in FIG. 3.
(3) Detection of touch by a human operator (human chess player) by a 3-D mask of their hand (think of this as a sheath or skin, generated by a trained system) colliding with the virtual chess piece that sheaths or skins the physical chess piece. That supports at least two actions within a chess game: “touching” and “letting go of”. These actions may be interpreted as “picking up” and “putting down.” A consequence is that the IPG System 102 supports software event traps that include context—for example triggering an event on a collision between two masks as opposed to triggering an event on an interpreted touched piece. This contextual eventing is effected at least as described with respect to blocks 318 and 320 in FIG. 3.
(4) Use of detected action to proceed to the next process step. In the case of a chess game, a countermove by the other chess player. Here application 128 is able to perform this capability by enlisting in an event that represents the detected action is at least as described with respect to blocks 318, 320, and 322 in FIG. 3.
(5) Detection of illegal moves. The IPG System may warn the operator, here a chess player, to help avert imminent errors. Again, application 128 is able to perform this capability by enlisting in an event that represents the detected action is at least as described with respect to blocks 318, 320, and 322 in FIG. 3.
(6) The IPG System may specify possible moves an operator may make, here a chess player, touches a piece. In fact, the system may specify better moves than the chess player is considering upon demand. This illustrates contextual procedural guidance. As with items 4 and 5 above, application 128 is able to perform this capability by enlisting in an event that represents the detected action, which is at least as described with respect to blocks 318, 320, and 322 in FIG. 3.

The above set of capabilities is described within the context of a chess game since it is more readily relatable for most people. However, note that in general, if a software handler can be programmed, any response to a recognized event is enabled. Turning to the context of a laboratory scenario, the capabilities of the IPG System 102 and the potential properties enabled by the IPG System 102 may be further illustrated in this context. Note that the term for a class of laboratory procedures or workflows is called a “protocol.”
(1) The IPG System 102 may make use of a particular video lash up to relay headset video to a centralized control monitor function (colloquially known as “mission control”). Mission control may involve a remote user monitoring the user in the AR/MR/XR environment. Alternatively, mission control may involve the remote user broadcasting the experience of the user in the AR/MR/XR environment to others. This may be achieved as follows. First, video for a particular user is captured by the user's Hololens 2™ front-facing camera using a Microsoft wireless display adapter (meant by Microsoft to be used to mirror monitors). This broadcasts to an HDMI Downsizer (for example from 4K resolution to 1080p) and is captured by a capture card usually on a personal computer. Data from the capture card is operated on by Open Broadcast Studio editing software (“OBS”) at a remote monitoring site, i.e., the “mission control.”. OBS may stream the data from the capture card. Then another user at mission control may potentially join a broadcasting software platform such as Microsoft Teams or Zoom, while using their own wireless headphones and microphone and sharing their OBS screen. In this way, third parties may monitor the activity of the user in the AR/MR/XR environment.
(2) The user in the AR/MR/XR environment may make use of various kinds of audio devices to relay audio to mission control including gaming-type wireless headphones. In effect, the wireless headphones are treated as part of DepthCam 114.
(3) The IPG System 102 may generate a floating (relative) checklist and time-stamped checklist, and transmission of the streaming of those checklists to mission control, which records them. In this way, mission control can either monitor or share to third parties the procedure/workflow of the user in the AR/MR/XR environment. This is an example of in block 310 of FIG. 3, that the incoming data need not be sensory data, but may be telemetry, or in this case lists.
(4) Laboratory protocol steps may be captured with a machine learning neural network specific to the protocol 124 to enable the IPG System 102 to identify missing objects and or out of order or improperly performed protocol steps. This is a direct emergent property from having a machine learning neural network 124 that is specific to the protocol as loaded in block 302 of FIG. 3, and as used to raise events and handle events in blocks 318, 320, and 322 of FIG. 3. Here, the application 128 may choose to create software handler 130 that displays an “expected objects panel” i.e., a list of objects that are to be detected for a particular protocol step. Key attributes of this expected objects panel are:
   a. Display a virtual panel that showcases the items required for each step.
   b. When an object is detected in the workspace, a label appears above said that object, with a countdown indicating it is detected and being confirmed (current plan is to “confirm” an item if it remains present in a scene for a predetermined time, such as 5 seconds).
   c. Once the item is “confirmed” the label has a virtual indicator, for example turning green and rising up and away from the item, fading as it goes. There may also be an audio indicator such as a sound cue being played by the IPG System when an item is confirmed.
   d. Step progression through a protocol is disabled until the items needed for said step are all present and “confirmed.”
   e. On the displayed panel of expected objects, a visual artifact may also be provided to provide status. For example, a checkmark may appear next to the confirmed item, or alternatively, the item may be wiped off the list of expected items, leaving behind only the items that are missing on the scene.
(5) The IPG System 102, specifically the machine learning neural network 124 trained on the protocol, may block step progression through the protocol until and unless correct objects are there. Step progression can be triggered by detected conditions including actions, are halted if actions not taken or objects not detected. Again, this is enabled by the event handling process as set forth in blocks 318, 320, and 322 of FIG. 3.
(6) Particular actions involving detecting hand activity may include unsupervised training of machine neural networks such as Object Contrastive Networks (OCNs) to recognize distinctive clusters of features including the location of key joints in fingers, hands, and wrists, tracked in time and space (by location in the local coordinate system (LCS)). This is a specialization of having a machine learning neural network 124 specific to the application 128 making use of fine-grained fidelity of interpreting hand movements and gestures.
(7) Alternatively, ad hoc methods to detect actions by the IPG System 102 may include detecting the key actions of touching and letting go of by collision of virtual hand sheathed around the physical hand, colliding with virtual sheathing around the touched object, which may be extremely versatile. Again, this is a specialization of having a machine learning neural network 124 specific to the application 128 making use of fine-grained fidelity of interpreting hand movements and gestures.

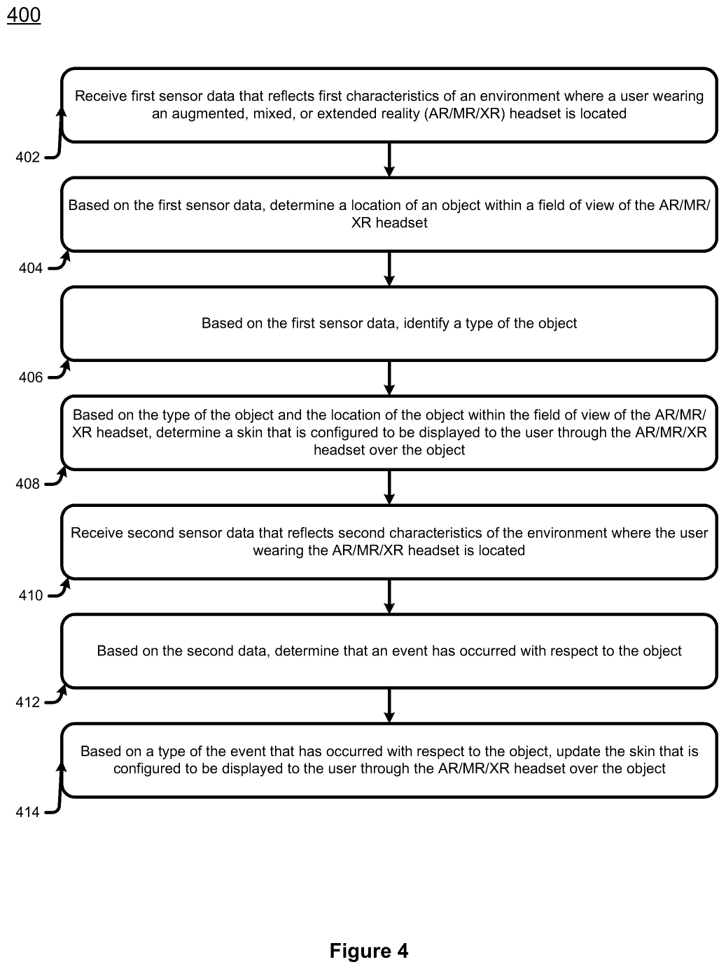

FIG. 4 is a flow chart of another exemplary operation of an Interactive Procedural Guidance System. In general, the process 400 receives sensor data of an environment around an AR/MR/XR headset. Based on the sensor data, the process 400 identifies an object in the environment and applies a skin to the object. The process 400 receives additional sensor data of the environment. Based on the additional sensor data, the process 400 determines that an event occurred with respect to the object and updates the skin based on the event. The process 400 will be described as being performed by the interactive procedural system 102 of FIG. 1 and will include references to other components in FIG. 1. In some implementations, the process 400 may be performed by one or more components illustrated in FIG. 2. In some implementations, the process 400 may be performed by one or more computing devices, including virtual computing devices.

The system 102 receives first sensor data that reflects first characteristics of an environment where a user wearing an augmented, mixed, or extended reality (AR/MR/XR) headset is located (402). In some implementations, the sensors are connected to the AR/MR/XR headset. For example, the AR/MR/XR headset may have a camera attached to it. The camera may be configured to capture the field of view of the AR/MR/XR headset. In some implementations, the sensors are connected to a fixed location in the environment around the AR/MR/XR headset. For example, a camera may be mounted to a workbench. The field of view of the camera may include some areas of the field of view of the AR/MR/XR headset. The sensors may include a camera, a time of flight sensor, a structured illumination sensor, an infrared sensor, a light detection and ranging scanner, a proximity sensor, a microphone, a gyroscope, an accelerometer, a proximity sensor, a gravity sensor, a thermometer, a humidity sensor, a magnetic sensor, a pressure sensor, a capacitive sensor, and/or any other similar type of sensor. In some implementations, a combination of sensors may be configured to sense depth in the field of view of the AR/MR/XR headset.

In some implementations, the sensors may generate sensor data and transmit the sensor data to the system 102 at a periodic interval, such as every minute. In some implementations, the sensors may generate the sensor data in response to a request from the system 102. In some implementations, the sensors may generate the sensor data based on the sensor data changing a threshold amount or a threshold percentage.

Based on the first sensor data, the system 102 determines a location of an object within a field of view of the AR/MR/XR headset (404). In some implementations, the system 102 may determine a distance between the object and the AR/MR/XR headset. This distance may change based on the movement of the AR/MR/XR headset. In some implementations, the system 102 may determine a pose of the object. The pose of the object may be the orientation of the object relative another objected or gravity. For example, the pose of beaker may be that the beaker is sitting upright. The pose of another beaker may be that it is on its side.

In some implementations, the system 102 may load a set of rules and/or a procedure. Based on the set of rules or the procedure, the system 102 may attempt to identify certain objects. For example, a laboratory procedure may be configured to identify lab equipment such as Bunsen burners, flasks, beakers, chemicals, volumes in containers, and/or any other similar equipment. The laboratory procedure may be configured to guide a user through a laboratory testing procedure while the user wears the AR/MR/XR headset. As another example, a set of chess rules may be configured to identify chess pieces. Based on the type of chess piece, the set of rules may specify how each piece is able to move. A user may touch a piece and the valid moves may be shown through the AR/MR/XR headset. If the user attempts to move a piece in a way that violates the rules, then the system 102 may provide an indication to the user through the AR/MR/XR headset.

Based on the first sensor data, the system 102 identifies a type of the object (406). In some implementations, the system 102 may identify the type of object based on the set or rules and/or procedure that the system 102 loaded. The set or rules and/or procedure may indicate specific objects to identify. The system 102 may use models trained using machine learning and/or deterministic techniques to analyze the sensor data and identify an object.

Based on the type of the object and the location of the object within the field of view of the AR/MR/XR headset, the system 102 determines a skin that is configured to be displayed to the user through the AR/MR/XR headset over the object (408). The set or rules and/or procedure may specify how to augment the object for the user of the AR/MR/XR headset. In some implementations, the system 102 may determine the skin further based on the distance between the object and the AR/MR/XR headset and/or based on the pose of the object. For example, flask that is upright and has a chemical in it may have a skin that identifies the chemical. A flask that is on its side and is in a puddle may have a skin that indicates danger to the user.

In some implementations, the skin may cause the object to appear larger to the user when the object is within the field of view of the AR/MR/XR headset. For example, an object that the user should avoid knocking over because it contains a caustic chemical may have a skin that is bigger than the object would appear to the user if the user were not wearing the AR/MR/XR headset. The size of the skin may change depending on the stage of the procedure. For example, a flask with water in it may not appear with a skin that is larger than the size of the flask, or even with a skin at all. If a chemical is added that causes the pH to drop below two, then the skin may cause the flask to appear larger to prevent the user from bumping into the flask and knocking it over during the rest of the procedure. Another example is when a Bunsen burner is burning, it may have a skin that appears larger than the Bunsen burner and/or the flame. The size of the skin may be based on the temperature of the area around the burner. The skin may end at the point were the temperature is below or above a threshold temperature level. The threshold temperature level may change based on the stage of the procedure and/or the other objects within the field of view of the AR/MR/XR headset. For example, if combustible or flammable objects are within the field of view of the AR/MR/XR headset, then the threshold may decrease. This may help prevent the user from bringing the combustible or flammable objects in close proximity to the flame or areas around the flame where the temperature is at least a threshold temperature, such as one hundred fifty degrees. The edge of the skin may be the point where the temperature drops below one hundred fifty degrees outside the edge of the skin. If there are no combustible or flammable objects are within the field of view of the AR/MR/XR headset, then the edge of the skin may be two hundred degrees.

In some implementations, the system 102 may determine the location and type of an additional object within the field of view of the AR/MR/XR headset. The system 102 may identify the additional object in a similar fashion to identifying the object. The system 102 may use the location and type of the additional object to determine the skin of the object. An example of this situation is the Bunsen burner example described above. The system 102 may adjust the skin of the Bunsen burner based on the type of objects within the field of view of the AR/MR/XR headset, the type of objects that have been within the field of view of the AR/MR/XR headset within a period of time, or the type of objects that should be present based on the stage of the procedure. The period of time may adjust based on a danger level of the object or the additional object. For example, if an object is more dangerous because of pH that is a threshold away from seven or because of a temperature that is above a threshold, then the period of time may increase. The period of time may increase more if the pH is one or fourteen compared to the pH of five or nine.

The system 102 receives second sensor data that reflects second characteristics of the environment where the user wearing the AR/MR/XR headset is located (410). The second sensor data may be generated by the same or a different set of sensors than the first sensor data. The sensors may be in a different location based on the movement of the user wearing the AR/MR/XR headset.

Based on the second data, the system 102 determines that an event has occurred with respect to the object (412). In some implementations, an event may be a change in the location of the object, a change in an additional location of an additional object, a change in a pose of the object or the additional object, a change in an additional pose of the additional object, a change in a first distance between the object and the AR/MR/XR headset, a change in a second distance between the additional object and the AR/MR/XR headset, a change in a third distance between the object and the additional object, and/or an interaction between the skin of the object and the user, the additional object, or an additional skin of the additional object. Other events may be changes to the object or the additional object as indicated by the procedure that the user is following. In other words, an event may be any change in the objects within the field of view of the AR/MR/XR headset or object that have been within the field of view of the AR/MR/XR headset during the past period of time.

For example, an event may occur if the skins of the object and the additional object touch. The skins may touch even without the objects touching if the skins are larger than the objects. If only one object has a skin, then the object may still not touch during an interaction between the skin of one object and the other object. This may also be because the skin is larger than the one object.

Based on a type of the event that has occurred with respect to the object, the system 102 updates the skin that is configured to be displayed to the user through the AR/MR/XR headset over the object (414). In some implementations, the system 102 accesses a set of rules or a procedure related to the activity of the user. This set of rules or procedure may be loaded to the AR/MR/XR headset when the user dons the AR/MR/XR headset. The skin may be updated based on the set of rules or procedure because the set of rules or procedure may indicate the objects that are likely within the field of view of the AR/MR/XR headset or within a threshold distance of the field of view of the AR/MR/XR headset.

In some implementations, the system 102 may classify the event. The classification may be based on the danger posed to the user as indicated by a score. For example, the system 102 may detect an interaction with the skin of an object that includes an acid with a pH of below two. The classification may indicate a danger with a score of 0.9. As another example, the system 102 may detect an interaction with the skin of an object that includes water. The classification may indicate a danger with a score of 0.2. As another example, the system 102 may detect an interaction with two pieces of a game. The system 102 may compare the interaction to the set of rules. If the interaction breaks the rules, then the system 102 may classify the danger with a score of 0. There may be danger to the user when working with chemicals but not when playing a game. Based on the score, the system 102 may update the skin to illustrate the danger to the user. The higher the score, the larger, brighter, and/or obvious, the update to the skin may be to the user.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving, by an interactive procedural system, first sensor data that reflects first characteristics of an environment where a user wearing an augmented, mixed, or extended reality (AR/MR/XR) headset is located;
based on the first sensor data, determining, by the interactive procedural system, a location of an object within a field of view of the AR/MR/XR headset;
based on the first sensor data, identifying, by the interactive procedural system, a type of the object;
based on the type of the object and the location of the object within the field of view of the AR/MR/XR headset, determining, by the interactive procedural system, a skin that is configured to be displayed to the user through the AR/MR/XR headset over the object;
receiving, by the interactive procedural system, second sensor data that reflects second characteristics of the environment where the user wearing the AR/MR/XR headset is located;
based on the second data, determining, by the interactive procedural system, that an event has occurred with respect to the object; and
based on a type of the event that has occurred with respect to the object, updating, by the interactive procedural system, the skin that is configured to be displayed to the user through the AR/MR/XR headset over the object.

2. The method of claim 1, wherein the first sensor data and the second sensor data are generated by sensors that (i) comprise a camera, a time of flight sensor, a structured illumination sensor, an infrared sensor, and a light detection and ranging scanner, (ii) that are integrated with the AR/MR/XR headset, and (ii) that are separate from the AR/MR/XR headset.

3. The method of claim 1, wherein:
determining the location of the object within the field of view of the AR/MR/XR headset comprises:
determining a distance between the object and the AR/MR/XR headset; and
determining a pose of the object, and
determining the skin that is configured to be displayed to the user through the AR/MR/XR headset over the object is based on the distance between the object and the AR/MR/XR headset and based on the pose of the object.

4. The method of claim 1, comprising:
based on the first sensor data, determining, by the interactive procedural system, an additional location of an additional object within a field of view of the AR/MR/XR headset;
based on the first sensor data, identifying, by the interactive procedural system, a type of the additional object,
wherein determining the skin of the that is configured to be displayed to the user through the AR/MR/XR headset over the object is further based on the type of the additional object and the additional location of the object within the field of view of the AR/MR/XR headset.

5. The method of claim 1, wherein the event that has occurred with respect to the object comprises:
a change in the location of the object;
a change in an additional location of an additional object;
a change in a pose of the object or the additional object;
a change in an additional pose of the additional object;
a change in a first distance between the object and the AR/MR/XR headset;
a change in a second distance between the additional object and the AR/MR/XR headset;
a change in a third distance between the object and the additional object; or
an interaction between the skin of the object and the user, the additional object, or an additional skin of the additional object.

6. The method of claim 1, wherein the skin causes the object to appear larger to the user when the object is within the field of view of the AR/MR/XR headset.

7. The method of claim 1, comprising:
accessing, by the interactive procedural system, a set of rules or a procedure related to an activity of the user,
wherein determining that the event has occurred with respect to the object is further based on the set or rules or the procedure, and
wherein updating the skin that is configured to be displayed to the user through the AR/MR/XR headset over the object is further based on the set of rules or the procedure.

8. A system, comprising:
one or more processors; and
memory including a plurality of computer-executable components that are executable by the one or more processors to perform a plurality of actions, the plurality of acts comprising:
receiving first sensor data that reflects first characteristics of an environment where a user wearing an augmented, mixed, or extended reality (AR/MR/XR) headset is located;
based on the first sensor data, determining a location of an object within a field of view of the AR/MR/XR headset;
based on the first sensor data, identifying a type of the object;
based on the type of the object and the location of the object within the field of view of the AR/MR/XR headset, determining a skin that is configured to be displayed to the user through the AR/MR/XR headset over the object;
receiving second sensor data that reflects second characteristics of the environment where the user wearing the AR/MR/XR headset is located;
based on the second data, determining that an event has occurred with respect to the object; and
based on a type of the event that has occurred with respect to the object, updating the skin that is configured to be displayed to the user through the AR/MR/XR headset over the object.

9. The system of claim 8, wherein the first sensor data and the second sensor data are generated by sensors that (i) comprise a camera, a time of flight sensor, a structured illumination sensor, an infrared sensor, and a light detection and ranging scanner, (ii) that are integrated with the AR/MR/XR headset, and (ii) that are separate from the AR/MR/XR headset.

10. The system of claim 8, wherein:
determining the location of the object within the field of view of the AR/MR/XR headset comprises:
determining a distance between the object and the AR/MR/XR headset; and
determining a pose of the object, and
determining the skin that is configured to be displayed to the user through the AR/MR/XR headset over the object is based on the distance between the object and the AR/MR/XR headset and based on the pose of the object.

11. The system of claim 8, wherein the plurality of acts comprise:
based on the first sensor data, determining an additional location of an additional object within a field of view of the AR/MR/XR headset;
based on the first sensor data, identifying a type of the additional object,
wherein determining the skin of the that is configured to be displayed to the user through the AR/MR/XR headset over the object is further based on the type of the additional object and the additional location of the object within the field of view of the AR/MR/XR headset.

12. The system of claim 8, wherein the event that has occurred with respect to the object comprises:
a change in the location of the object;
a change in an additional location of an additional object;
a change in a pose of the object or the additional object;
a change in an additional pose of the additional object;
a change in a first distance between the object and the AR/MR/XR headset;
a change in a second distance between the additional object and the AR/MR/XR headset;
a change in a third distance between the object and the additional object; or
an interaction between the skin of the object and the user, the additional object, or an additional skin of the additional object.

13. The system of claim 8, wherein the skin causes the object to appear larger to the user when the object is within the field of view of the AR/MR/XR headset.

14. The system of claim 8, wherein the plurality of acts comprise:
accessing a set of rules or a procedure related to an activity of the user,
wherein determining that the event has occurred with respect to the object is further based on the set or rules or the procedure, and
wherein updating the skin that is configured to be displayed to the user through the AR/MR/XR headset over the object is further based on the set of rules or the procedure.

15. One or more non-transitory computer-readable media storing computer-executable instructions that upon execution cause one or more computers to perform acts comprising:
receiving first sensor data that reflects first characteristics of an environment where a user wearing an augmented, mixed, or extended reality (AR/MR/XR) headset is located;
based on the first sensor data, determining a location of an object within a field of view of the AR/MR/XR headset;
based on the first sensor data, identifying a type of the object;
based on the type of the object and the location of the object within the field of view of the AR/MR/XR headset, determining a skin that is configured to be displayed to the user through the AR/MR/XR headset over the object;
receiving second sensor data that reflects second characteristics of the environment where the user wearing the AR/MR/XR headset is located;
based on the second data, determining that an event has occurred with respect to the object; and
based on a type of the event that has occurred with respect to the object, updating the skin that is configured to be displayed to the user through the AR/MR/XR headset over the object.

16. The media of claim 15, wherein the first sensor data and the second sensor data are generated by sensors that (i) comprise a camera, a time of flight sensor, a structured illumination sensor, an infrared sensor, a light detection and ranging scanner, (ii) that are integrated with the AR/MR/XR headset, and (ii) that are separate from the AR/MR/XR headset.

17. The media of claim 15, wherein:
determining the location of the object within the field of view of the AR/MR/XR headset comprises:
determining a distance between the object and the AR/MR/XR headset; and
determining a pose of the object, and
determining the skin that is configured to be displayed to the user through the AR/MR/XR headset over the object is based on the distance between the object and the AR/MR/XR headset and based on the pose of the object.

18. The media of claim 15, wherein the acts comprise:
based on the first sensor data, determining an additional location of an additional object within a field of view of the AR/MR/XR headset;
based on the first sensor data, identifying a type of the additional object, wherein determining the skin of the that is configured to be displayed to the user through the AR/MR/XR headset over the object is further based on the type of the additional object and the additional location of the object within the field of view of the AR/MR/XR headset.

19. The media of claim 15, wherein the event that has occurred with respect to the object comprises:
a change in the location of the object;
a change in an additional location of an additional object;
a change in a pose of the object or the additional object;
a change in an additional pose of the additional object;
a change in a first distance between the object and the AR/MR/XR headset;
a change in a second distance between the additional object and the AR/MR/XR headset;
a change in a third distance between the object and the additional object; or
an interaction between the skin of the object and the user, the additional object, or an additional skin of the additional object.

20. The media of claim 15, wherein the skin causes the object to appear larger to the user when the object is within the field of view of the AR/MR/XR headset.
